(19) United States
(12) Patent Application Publication
(10) Pub. No.: US 2011/0145155 A1
(43) Pub. Date: Jun. 16, 2011

(54) Methods, Systems, and Products for Predicting Work force Requirements

(76) Inventors: Robert A. Walter, Atlanta, GA (US); Alfonso Jones, Suwanee, GA (US); Terri H. Pifer, Kennesaw, GA (US)

(21) Appl. No.: 12/635,898

(22) Filed: Dec. 11, 2009

(51) Int. Cl. G06Q 10/00; G06Q 50/00

(52) U.S. Cl. 705/301; 705/348

(57) ABSTRACT

Methods, systems, and products are disclosed for predicting work force requirements. Work order information is retrieved describing work orders, and weather information is retrieved describing a weather event. The work order information and the weather information are combined to determine an impact on the work orders due to the weather event. The work force requirements are then predicted to resolve the work orders.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Exemplary embodiments generally relate to work orders and work force management to resolve the work orders.

Efficient deployment of work forces is desired. Small businesses to large corporations strive to quickly resolve customer issues without incurring excessive labor costs. Accurate prediction of work force needs may thus help reduce labor and equipment costs.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIGS. 1 and 2 are schematics illustrating an environment in which exemplary embodiments may be implemented;

FIG. 3 is a schematic illustrating another environment in which exemplary embodiments may be implemented;

FIG. 4 is a schematic illustrating various databases, according to exemplary embodiments;

FIGS. 5 and 6 are schematics illustrating a business management application, according to exemplary embodiments;

FIG. 7 is a generic block diagram illustrating the business management application operating within a processor-controlled device, according to exemplary embodiments; and

FIG. 8 depicts other possible operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

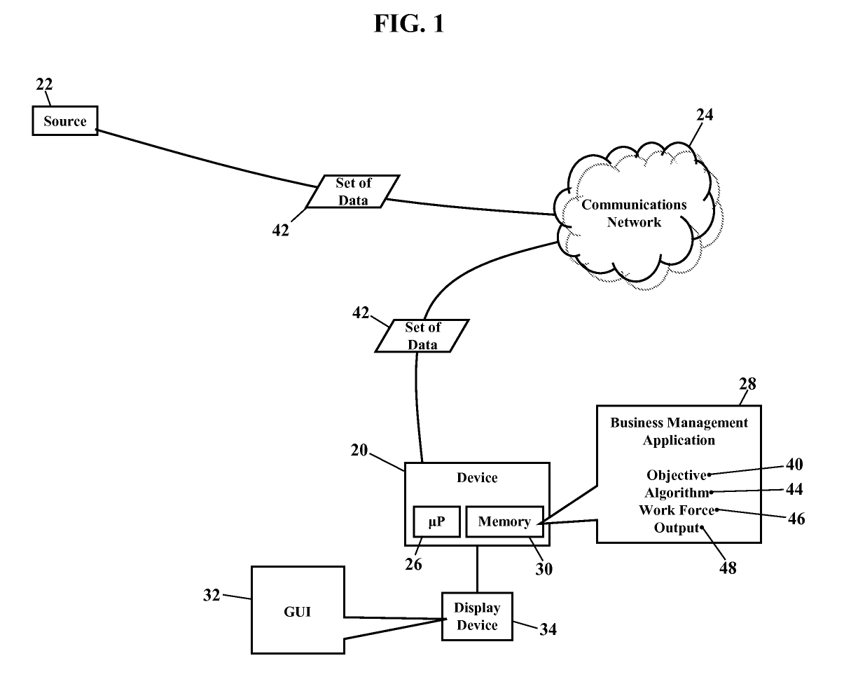

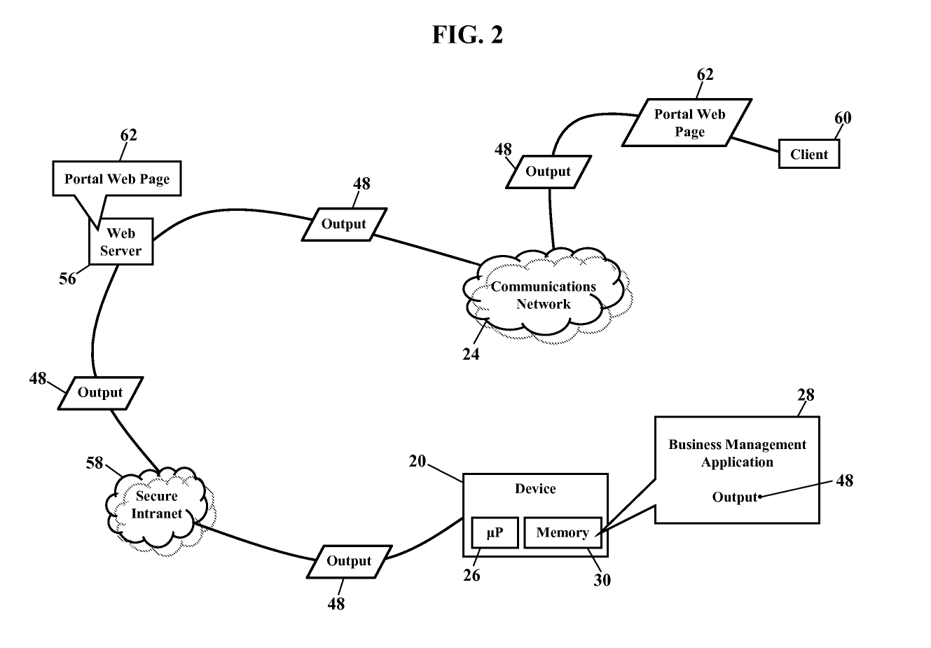

FIGS. 1 and 2 are schematics illustrating an environment in which exemplary embodiments may be implemented. FIG. 1 illustrates a client-server network architecture, and FIG. 2 illustrates a web-based environment. Starting with FIG. 1, a device 20 communicates with a source 22 of data via a communications network 24. The device 20 has a processor 26 (e.g., “μP”), application specific integrated circuit (ASIC), or other component that executes a business management application 28 stored in a memory 30. The business management application 28 may cause the processor 26 to produce a graphical user interface 32. The graphical user interface 32 is illustrated as being visually produced on a display device 34, yet the graphical user interface 32 may also have audible features. Although the device 20 is generically shown, the device 20, as later paragraphs will explain, may be a server, workstation, communications device, or any processor-controlled device.

The business management application 28 may predict work force requirements. According to exemplary embodiments, the business management application 28 includes one or more sets of processor-executable instructions that predict what personnel, and/or how many personnel, may be needed to meet some objective 40. The business management application 28, for example, may predict the number of employees needed to complete a project, to construct a building, or to repair a machine. The business management application 28 retrieves a set 42 of data and applies the set 42 of data to an algorithm 44. The set 42 of data is illustrated as being remotely retrieved via the communications network 24 from the source 22. The set 42 of data, however, may be locally retrieved from the memory 30 of the device 20. Regardless, the business management application 28 may predict the work force 46 needed to meet the objective 40. The business management application 28 may then generate an output 48, and the output 48 may include the set 42 of data, the work force 46, and/or the objective 40. The output 48, for example, may be a web page, a file, and/or a graphical user interface.

The business management application 28 may be accessed from a web-based portal. As FIG. 2 illustrates, the business management application 28 may communicate with, or be accessed from, a web server 56. FIG. 2 illustrates the output 48 communicating via a secure intranet 58 to the web server 56. The web server 56 stores the output 48 in memory for distribution to a client 60. The web server 56, for example, may store a portal web page 62 that is accessed and downloaded from the communications network 24. The client 60 communicates with the web server 56 and downloads the portal web page 62. The portal web page 62 may require authentication credentials (such as a secure username and password). When the client 60 successfully authenticates, the web server 56 and/or the portal web page 62 allows the client 60 to download the output 48. The client 60 may then visually display and/or audibly produce the output 48. The client 60, for example, may render the output 48 as HTML, javascript, and/or other code or content.

The device 20, the web server 56, and the client 60 are only simply illustrated. Because the architecture and operating principles of processor-controlled devices are well known, their hardware and software components are not further shown and described. If the reader desires more details, the reader is invited to consult the following sources: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} E.d 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

Exemplary embodiments may be applied regardless of networking environment. The communications network 24 may be a cable network operating in the radio-frequency domain and/or the Internet Protocol (IP) domain. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the I.E.E.E. 802 family of standards, GSM/CDMA/TDMA or any cellular standard, and/or the ISM band). The communications network 24 may even include powerline portions, in which signals are communicated via electrical wiring. The concepts described herein may be applied to any wireless/wireline communications network, regardless of physical componentry, physical configuration, or communications standard(s).

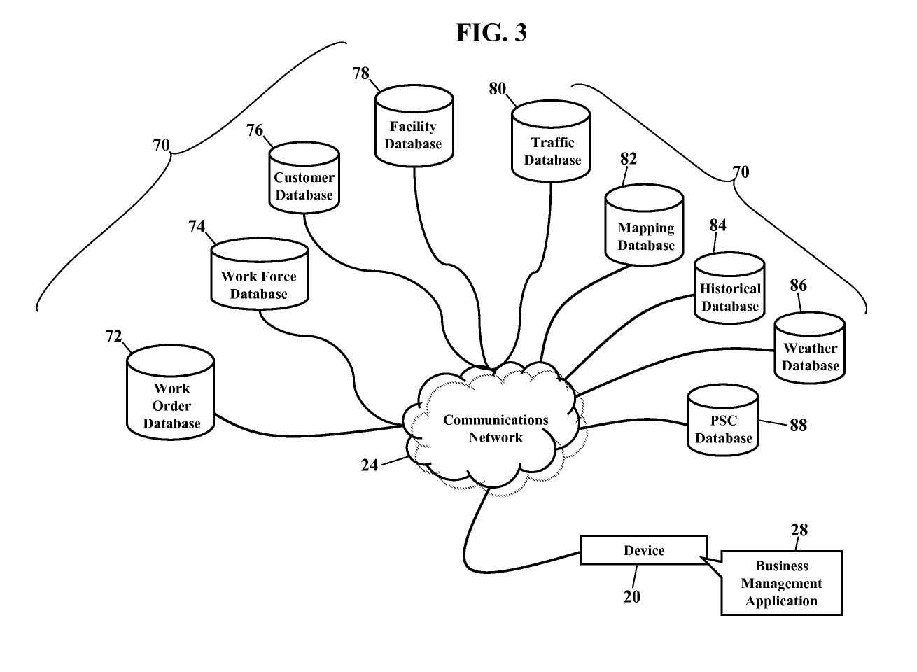

FIG. 3 is a schematic illustrating another environment in which exemplary embodiments may be implemented. Here the device 20 may access one or more databases 70 to acquire the set 30 of data. That is, the business management application 28 may query any of the databases 70 for information that helps predict work force requirements. The various databases 70 are illustrated as being remotely located from the device 20. That is, the device 20 may query the databases 70 (via the communications network 24) to obtain information. The various databases 70, however, may be locally stored in the device 20. A work order database 72, for example, stores work order information related to work orders. A work force database 74 stores work force information for a pool of employees, contractors, and other workers. A customer database 76 stores information on customers or subscribers. A facility database 78 stores facility information describing buildings, infrastructure, and other assets. A traffic database 80 may store delayed, near real-time, or real-time traffic information describing congestion on roadways. A mapping database 82 may store street indexes to generate driving maps and distance information. A historical database 84 may store historical information describing past work force needs. A weather database 86 stores delayed, near real-time, or real-time weather information. A public service commission (“PSC”) database 88 stores rules, regulations, and/or utility information available from a state and/or Federal public service commission. As the following paragraphs explain, the business management application 28 may query any of the databases 70 for information that helps predict work force requirements.

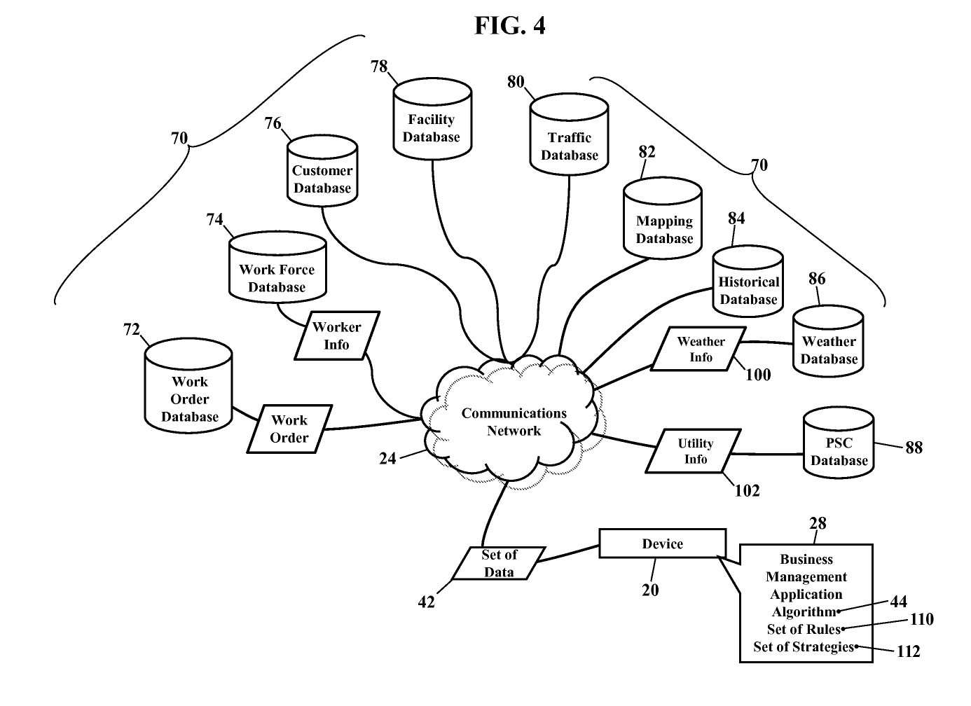

FIG. 4 is a schematic further illustrating databases 70, according to exemplary embodiments. The work force database 74 stores worker information associated with each worker. The work force database 74, for example, may store a worker's name, address, work schedule(s), vacation schedule(s), working hours, accumulated working hours (daily, weekly, monthly, and/or yearly), and accumulated overtime hours (again daily, weekly, monthly, and/or yearly). The work force database 74 may also store one or more skills sets associated with each worker. The work force database 74 may also store a current location associated with each worker.

The historical database 84 may store historical information describing past work force needs. The historical database 84, for example, may store tables that associate objectives to historical work force requirements. The historical database 84 may associate past maintenance tasks to the number of workers required to complete each maintenance task. The historical database 84 may even associate one or more specialized workers with particular repair, so that the specialized workers may be quickly recalled for the same repair. The historical database 84 may associate past work force requirements for past objectives. If the same objective needs to again be performed, the historical database 84 may help predict work force requirements.

The traffic database 80 may store delayed, near real-time, or real-time traffic information. The traffic information, for example, may describe congestion on roadways. The traffic database 80 may store street indexes to generate driving maps and distance information. The traffic database 80 may also store terrain information, such as elevations and contours. The business management application 28 may thus use the traffic database 80 to generate street maps and driving directions and to estimate driving distances to a particular location.

The business management application 28 may also access the weather database 86. The weather database 86 stores delayed, near real-time, or real-time weather information 100 associated with a location. The weather database 86, for example, may provide a Doppler radar data feed to the business management application 28. The Doppler data feed may then be used to predict work force requirements given the weather conditions, as later paragraphs will explain.

The business management application 28 may also access the public service commission (or “PSC”) database 88. The public service commission database 88 stores utility information 102 available from a state and/or Federal public service commission. The public service commission database 88, for example, may store rules, regulations, and compliance information associated with gas, water, electric, and telecommunications utilities. The public service commission database 88 may even store utility information for private utilities, such as private water/gas wells and private electrical generation (e.g., solar panels). The utility information 102 may then be used to predict work force requirements, as later paragraphs will explain.

The business management application 28 may thus use the databases 70 to predict work force requirements. The business management application 28 retrieves information from one or more of the databases 70 and predicts what workers, and/or how many workers, may be needed to meet the objective 40. The business management application 28 may use information from one or more of the databases 70 to solve the algorithm 44. The business management application 28 may additionally or alternatively apply a set 110 of rules and/or a set 112 of strategies to predict work force requirements. The set 110 of rules and/or the set 112 of strategies may include artificial intelligence or fuzzy-logic based statements that improve work force predictions. The business management application 28 may thus use static and/or dynamic information from the databases 70, and incorporate historical trends from the historical database 84, to predict and/or dispatch a work force. The business management application 28, for example, may use the set 110 of rules and/or the set 112 of strategies to reduce the amount of overtime incurred by the work force while still satisfying utility compliance requirements from the public service commission database 88. The business management application 28 may thus monitor the progress/completion of tasks to ensure customer needs are satisfied while reducing overtime costs.

The business management application 28 thus provides a single, company-wide knowledge tool. Because the business management application 28 may accept static and dynamic feeds from any data source, the business management application 28 is thus a single software platform for use in all areas of a business. The business management application 28 thus eliminates multiple software platforms, and reduces IT costs and licensing fees. The commonality of the business management application 28 also permits increased efficiencies in both field and center operations. The business management application 28 thus transforms a diverse, multi-application force-to-load dispatch model into an intelligent business decision tool for all operations.

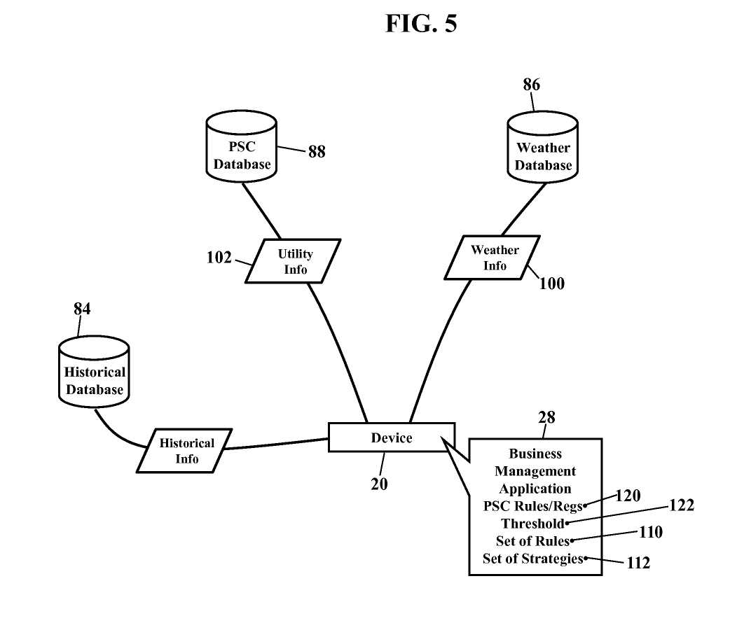

FIG. 5 is a schematic further illustrating the business management application 28, according to exemplary embodiments. Here the business management application 28 receives the real-time weather information 100 (such as the Doppler feed) from the weather database 86. The business management application 28, for example, may use current weather conditions and forecasted weather conditions to predict the number of required workers before, during, and/or after a weather event. As a storm approaches, the business management application 28 may use the historical database 84 and the weather information 100 to predict additional workers will be needed to repair storm damage.

The business management application 28 may also use the utility information 102 from the public service commission database 88. Here the business management application 28 evaluates the utility information 102 to determine whether utility rules and regulations are satisfied. Some public service commissions, for example, may require that ninety five percent (95%) or more of service outages are repaired, or “cleared,” within twenty four (24) hours. Other rules or regulations may require:
Trouble reports cleared within 36 hours >77%,
Out of Service cleared within 8 working hours >90%,
Installation completed within 5 days >90%,
IPTV repairs within 72 hours >95%, and
Repeat reports (repair) per 100 access lines <=1.0.
   The business management application 28 may thus compare the utility information 102 from the public service commission database 88 to PSC rules & regulations 120. When the business management application 28 learns that one or more of the PSC rules & regulations 120 are satisfied, the business management application 28 may then implement the set 112 of strategies to conserve resources and/or gain advantages.

A few scenarios help explain the PSC rules & regulations 120. Suppose a state's public service commission requires that 90% of all utility installation requests are completed within five (5) days. When the business management application 28 retrieves the utility information 102, the business management application 28 learns that currently 95% of all installation requests have been completed within five (5) days. The PSC rules & regulations 120, in other words, have been safely exceeded. Because the PSC rules & regulations 120 have been exceeded, the business management application 28 may reduce or deny worker overtime to reduce labor costs. Similarly, suppose the utility information 102 indicates that 88% of all trouble reports have been cleared or completed within the past thirty six (36) hours. The PSC rules & regulations 120, however, only require 77% compliance. Again, the PSC rules & regulations 120 have been exceeded, so the business management application 28 may reduce or deny worker overtime. The business management application 28 may even “pull” from jobs and reassign workers to higher priority efforts. Or, the business management application 28 may grant more vacation requests to build team spirit, to reduce worker fatigue, or to achieve some other strategy. The business management application 28 may thus compare one or more current values of the utility information 102 to threshold values 122 of the PSC rules & regulations 120. When the current value of the utility information 102 equals or exceeds the threshold value 122, the business management application 28 may then implement alternate strategies to conserve resources and/or gain advantages.

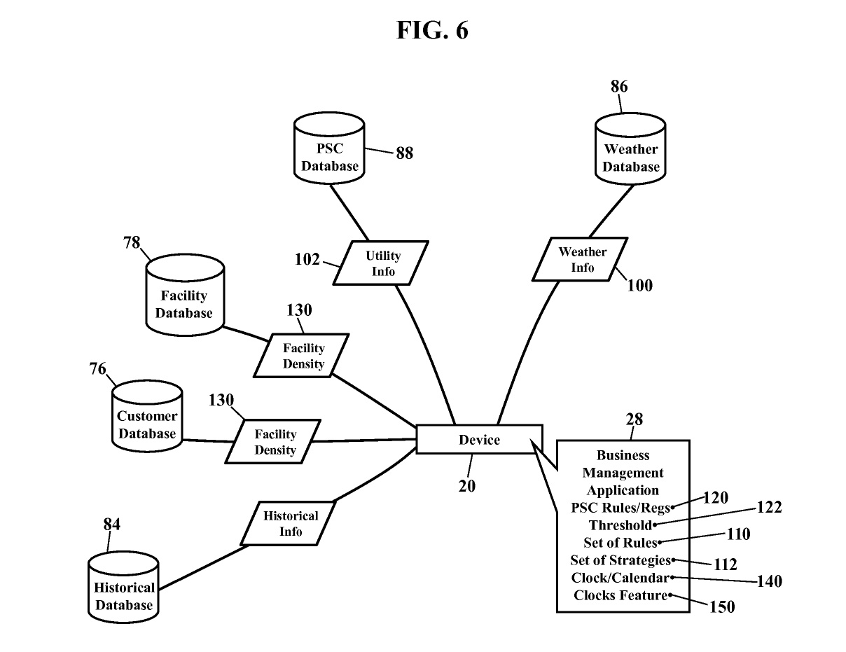

FIG. 6 is a schematic further illustrating the business management application 28, according to exemplary embodiments. Here the business management application 28 may retrieve a facility density 130 from the customer database 76 and/or the facility database 78. The facility density 130, for example, may describe a density measurement of facilities per some location or area. The facility density 130 may describe the number of telecommunications wire centers per region or the number of access lines per square mile. The facility density 130, likewise, may describe the number of cable converters or set-top boxes per region or per square mile. The facility density 130 may also describe the number of electric meters, water meters, or other infrastructure equipment per region or area. The business management application 28 may then select a dispatch strategy from the set 112 of strategies based on the facility density 130.

The business management application 28 may also have a clock and calendar input 140. The clock and calendar input 140 provides at least a time and date. The business management application 28 may then use the clock and calendar input 140 to predict work force requirements. The business management application 28, for example, may provide a clock management tool with flexibility for different job types associated with unique dispatch strategies and metrics. The business management application 28 may analyze the impact of carrying over a load from a previous day after analysis of overtime, force-to-load, PSC penalties, and future weather forecast. The business management application 28 may also consider daylight savings time and longer/shorter daylight hours. Technicians, for example, may be dispatched from “dawn 'til dusk” instead of “8 to 5.” The business management application 28 may thus use the clock and calendar input 140 to receive daily sunrise and sunset times when predicting work force needs.

The business management application 28 may also use artificial intelligence when predicting work force demands. The business management application 28 receives the weather information, the conditions, PSC rules & regulations 120, overtime information from the work force database 74, the clock and calendar input 140, additional (flex) force needs from the work order database 72 and/or the work force database 74, and the facility density 130. The business management application 28 may also retrieve the historical information from the historical database 84. The business management application 28 may then compare this set 42 of data and apply the set 110 of rules and/or the set 112 of strategies. The business management application 28, in other words, may use artificial intelligence or fuzzy-logic based rules to predict work force needs, perhaps based on historical trends/events.

Approaching storms, for example, may cause the business management application 28 to increase the work force. As a storm moves west-to-east, the business management application 28 may forecast the amount of force necessary to clear all field work before the storm arrives in each local area. The eastern states can prepare to move workers and equipment, and plan for any additional (flex) force or overtime as necessary, based on the intensity of the storm and comparisons to other areas with similar geographic/density make-ups.

The business management application 28 may also predict work force needs for IPTV. Internet Protocol television (or “IPTV”) is an emerging technology, and AT&T® offers U-VERSE® as an IPTV service. AT&T's U-VERSE® service commits to a two-hour access window and on-site, on-time service is more important than meeting the two-hour commitment time. The commitment time is 4-6 hours beyond the “end access” window. The business management application 28 may thus dispatch technicians based on the access window as opposed to meeting the commitment time.

The business management application 28 may also correlate turfs and clocks. The business management application 28 may include a clocks feature 150. When the clocks feature 150 is disabled, or “off,” in low density wire centers, all turfs will be suspended on technician profiles preventing dispatch into the wire center. When the clocks feature 150 is enabled, or “on,” the turfs will automatically activate in Technician profiles allowing travel to the remote area.

The business management application 28 may select a dispatch strategy for rural areas. When the facility density 130 is low (as in more rural areas), the set 110 of rules and/or the set 112 of strategies may cause the business management application 28 to implement different dispatch strategies. In rural areas, for example, the business management application 28 may send technicians to an area based on a designated frequency as well as the other variables indicated above. This rural strategy may reduce the number of inefficient truck rolls to a sparsely populated or rural area.

As another example, the business management application 28 may quantify approaching weather events. Suppose the business management application 28 receives a Doppler radar data feed as the weather information 100. The business management application 28 may combine the Doppler radar data feed with the facility density 130 to accurately predict the impact of an approaching weather event. The business management application 28 may combine the Doppler data feed with the facility density 130 and with the historical information, using the equation

Weather Impact=DₒₚF_{d}Hᵢ, (Equation 1)

where Dₒₚ is the Doppler data feed, F_{d} is the facility density 130, and Hᵢ is the historical information. The quantity (DₒₚF_{d}) estimates the effect of the approaching weather front on a utility's infrastructure. If a severe storm approaches, the Doppler data feed Dₒₚ will have a higher value. If the severe storm approaches a densely populated area, the facility density 130 (F_{d}) may be high. Hence the quantity (DₒₚF_{d}) will have a larger value, indicating the approaching storm may have a great impact on the utility's infrastructure. Many customers, in other words, may be affected. If, on the other hand, the severe storm approaches a sparsely populated area, the facility density 130 (F_{d}) may be low. The quantity (DₒₚF_{d}) may thus have a smaller value that indicates only a relatively small number of customers will be affected. If only scattered, high altitude rain approaches, the Doppler data feed Dₒₚ may have a low value, and the quantity (DₒₚF_{d}) may have a small value for even densely populated areas. A low-valued Doppler data feed Dₒₚ that approaches a sparsely populated area produces a low quantity (DₒₚF_{d}), perhaps indicating a negligible impact on facilities.

The business management application 28, however, may also consider historical trends. Even though a severe storm approaches a densely populated area, the historical information (Hᵢ) may reveal that only 20% of facilities have been historically affected by a similar value of the Doppler data feed Dₒₚ. The quantity (DₒₚF_{d}) may thus be reduced, or discounted, by the historical information. Hence the impact of the approaching weather may be estimated by the quantity DₒₚF_{d}Hᵢ. If a severe storm approaches a densely populated area with high historical repairs, then the quantity DₒₚF_{d}Hᵢ may have a large value. The business management application 28 may thus predict a large increase in work force demands. If, however, the facilities are historically unaffected by severe storms, then the quantity DₒₚF_{d}Hᵢ may be small, perhaps causing the business management application 28 to predict little or no change in work force demands.

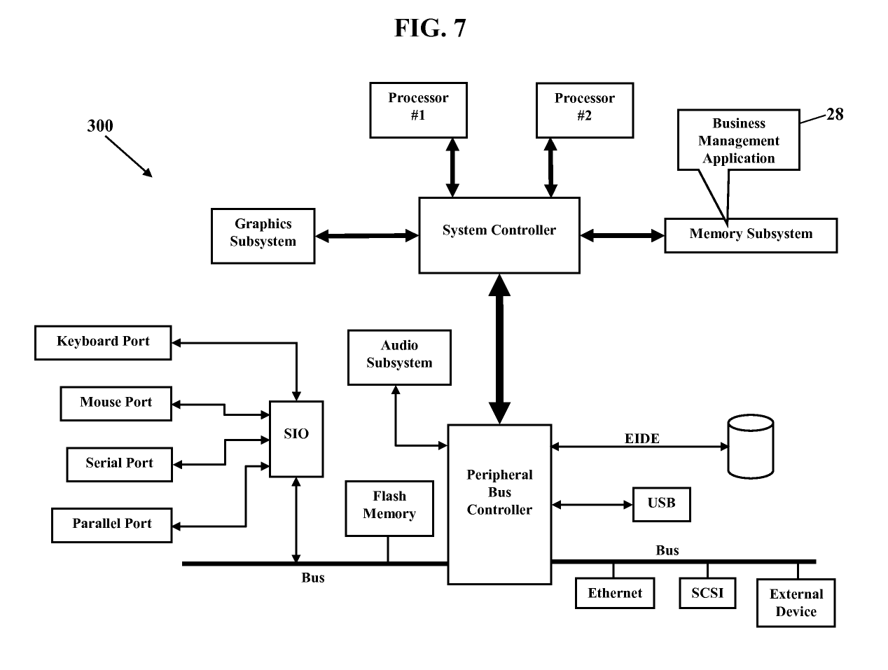

FIG. 7 is a schematic illustrating still more exemplary embodiments. FIG. 7 is a generic block diagram illustrating the business management application 28 operating within a processor-controlled device 300. As the above paragraphs explained, business management application 28 may operate in any processor-controlled device 300. FIG. 7, then, illustrates the business management application 28 stored in a memory subsystem of the processor-controlled device 300. One or more processors communicate with the memory subsystem and execute the software algorithm 30. Because the processor-controlled device 300 illustrated in FIG. 7 is well-known to those of ordinary skill in the art, no detailed explanation is needed.

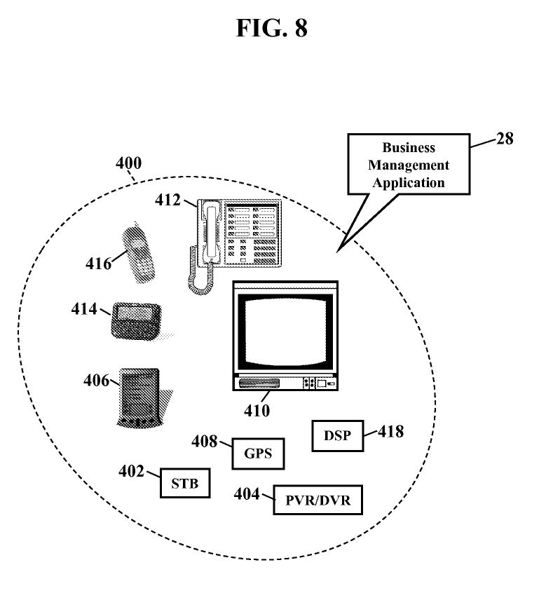

FIG. 8 depicts other possible operating environments for additional aspects of the exemplary embodiments. FIG. 8 illustrates the business management application 28 operating within various other devices 400. FIG. 8, for example, illustrates that the business management application 28 may entirely or partially operate within a set-top box (“STB”) (402), a personal/digital video recorder (PVR/DVR) 404, personal digital assistant (PDA) 406, a Global Positioning System (GPS) device 408, an interactive television 410, an Internet Protocol (IP) phone 412, a pager 414, a cellular/satellite phone 416, or any computer system, communications device, or processor-controlled device utilizing the processor 50 and/or a digital signal processor (DP/DSP) 418. The device 400 may also include watches, radios, vehicle electronics, clocks, printers, gateways, mobile/implantable medical devices, and other apparatuses and systems. Because the architecture and operating principles of the various devices 400 are well known, the hardware and software componentry of the various devices 400 are not further shown and described. If, however, the reader desires more details, the reader is invited to consult the following sources: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

Exemplary embodiments may be physically embodied on or in a computer-readable storage medium. This computer-readable medium may include CD-ROM, DVD, tape, cassette, floppy disk, memory card, and large-capacity disks. This computer-readable medium, or media, could be distributed to end-subscribers, licensees, and assignees. These types of computer-readable media, and other types not mention here but considered within the scope of the exemplary embodiments. A computer program product comprises processor-executable instructions for predicting work force needs, as explained above.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for predicting work force requirements, comprising:
retrieving work order information describing work orders;
retrieving weather information describing a weather event;
combining the work order information and the weather information to determine an impact on the work orders due to the weather event; and
predicting the work force requirements to resolve the work orders.

2. The method according to claim 1, further comprising retrieving utility information from a database storing public service commission information.

3. The method according to claim 2, further comprising comparing the utility information to a threshold to comply with public service commission requirements.

4. The method according to claim 3, further comprising reducing overtime hours when the utility information exceeds the threshold.

5. The method according to claim 1, further comprising estimating a driving distance to complete a work order.

6. The method according to claim 1, further comprising retrieving a facility density describing a density of facilities.

7. The method according to claim 6, further comprising selecting a dispatch strategy based on the facility density.

8. A system, comprising:
a processor executing code stored in memory, the code causing the processor to:
retrieve work order information describing work orders;
retrieve a facility density describing a density of facilities;
retrieve weather information describing a weather event;
combine the work order information, the facility density, and the weather information to determine an impact on the work orders due to the weather event; and
predict the work force requirements to resolve the work orders.

9. The system according to claim 8, further comprising code that causes the processor to retrieve utility information from a database storing public service commission information.

10. The system according to claim 9, further comprising code that causes the processor to compare the utility information to a threshold to comply with public service commission requirements.

11. The system according to claim 10, further comprising code that causes the processor to reduce overtime hours when the utility information exceeds the threshold.

12. The system according to claim 8, further comprising code that causes the processor to estimate a driving distance to complete a work order.

13. The system according to claim 8, further comprising code that causes the processor to select a dispatch strategy based on the facility density.

14. The system according to claim 8, further comprising code that causes the processor to retrieve sunrise and sunset times.

15. A computer readable medium storing processor executable instructions for performing a method, the method comprising:
retrieving work order information describing work orders;
retrieving a facility density describing a density of facilities;
retrieving Doppler information describing a weather event;
multiplying the facility density by the Doppler information to determine an impact on the work orders due to the weather event; and
predicting the work force requirements to resolve the work orders.

16. The computer readable medium according to claim 15, further comprising instructions for retrieving utility information from a database storing public service commission information.

17. The computer readable medium according to claim 16, further comprising instructions for comparing the utility information to a threshold to comply with public service commission requirements.

18. The computer readable medium according to claim 17, further comprising instructions for reducing overtime hours when the utility information exceeds the threshold.

19. The computer readable medium according to claim 16, further comprising instructions for estimating a driving distance to complete a work order.

20. The computer readable medium according to claim 16, further comprising instructions for retrieving sunrise and sunset times.
